(19) United States
(12) Patent Application Publication
(10) Pub. No.: US 2022/0391134 A1
(43) Pub. Date: Dec. 8, 2022

(54) TRACKING DATA LOCATIONS FOR IMPROVED MEMORY PERFORMANCE

(71) Applicant: Micron Technology, Inc., Boise, ID (US)

(72) Inventor: David Aaron Palmer, Boise, ID (US)

(21) Appl. No.: 17/338,455

(22) Filed: Jun. 3, 2021

(51) Int. Cl. G06F 3/06

(52) U.S. Cl. CPC G06F 3/0659; G06F 3/0644; G06F 3/0665; G06F 3/0652; G06F 3/0604; G06F 3/0679

(57) ABSTRACT

Methods, systems, and devices for tracking data locations for improved memory performance are described. A logical address space may be partitioned into ranges of logical addresses. A group of designators may be provided for each physical partition. Each designator may correspond to a respective logical partition. The memory system may determine the logical partition associated with data written to a physical partition and set the corresponding designator, if it is not already set, in the group associated with the physical partition. Upon receipt of a command (e.g., from a host device) to perform a purge on physical partitions containing data associated with a particular logical partition, the memory system may determine the affected physical partitions based on the designator corresponding to the logical partition being set in the respective groups and may perform the selective purge on those physical partitions.

### FIELD OF TECHNOLOGY

The following relates generally to one or more systems for memory and more specifically to tracking data locations for improved memory performance.

### BACKGROUND

Memory devices are widely used to store information in various electronic devices such as computers, user devices, wireless communication devices, cameras, digital displays, and the like. Information is stored by programing memory cells within a memory device to various states. For example, binary memory cells may be programmed to one of two supported states, often corresponding to a logic 1 or a logic 0. In some examples, a single memory cell may support more than two possible states, any one of which may be stored by the memory cell. To access information stored by a memory device, a component may read, or sense, the state of one or more memory cells within the memory device. To store information, a component may write, or program, one or more memory cells within the memory device to corresponding states.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), 3-dimensional cross-point memory (3D cross point), not-or (NOR) and not-and (NAND) memory devices, and others. Memory devices may be volatile or non-volatile. Volatile memory cells (e.g., DRAM cells) may lose their programmed states over time unless they are periodically refreshed by an external power source. Non-volatile memory cells (e.g., NAND memory cells) may maintain their programmed states for extended periods of time even in the absence of an external power source.

### BRIEF DESCRIPTION OF THE DRAWINGS

FIG. 1 illustrates an example of a system that supports tracking data locations for improved memory performance in accordance with examples as disclosed herein.

FIG. 2 illustrates an example of block diagram that supports tracking data locations for improved memory performance in accordance with examples as disclosed herein.

FIG. 3 shows a flow chart illustrating a method that supports tracking data locations for improved memory performance in accordance with examples as disclosed herein.

FIG. 4 shows a flow chart illustrating a method that supports tracking data locations for improved memory performance in accordance with examples as disclosed herein.

FIG. 5 shows a block diagram of a memory system that supports tracking data locations for improved memory performance in accordance with examples as disclosed herein.

FIGS. 6 through 8 show flowcharts illustrating methods that support tracking data locations for improved memory performance in accordance with examples as disclosed herein.

### DETAILED DESCRIPTION

In some memory systems, a host device may associate data with a logical address, which a memory system may map to a physical memory location in connection with storing the data. In response to the host device updating the data associated with a logical address (e.g., writes new data to the logical address), the memory system may write the new data to a new physical memory location, different than the original memory location, and remap the logical address to the new physical memory location. The original data, though now outdated, may remain in the old memory location. This may be undesirable, even if the old data is now outdated, especially if the old data corresponds to sensitive information (e.g., a password). For example, a hacker might glean a lot of information about a person from an old password. And because the associated logical address has been remapped to a different physical memory location, some memory systems may not keep track of where the old data may be stored.

In some memory systems, purge commands may be performed to clean (e.g., erase data from) portions (e.g., blocks) of physical memory. The purge may include moving valid data to other portions of memory, known as garbage collection, before performing the cleaning. Garbage collection of a block may refer to a set of media management operations that include, for example, selecting pages in the block that contain valid data, copying the valid data from the selected pages to new locations (e.g., free pages in another block), marking the data in the previously selected pages as invalid, and erasing the selected block. Because the memory system may not know where old data may have been stored, a purge of all of the physical memory (e.g., a system purge) may be performed to make sure the old data has been erased. Because of the amount of garbage collection this can entail, this may take a long time (e.g., up to hours on large systems) and result in lost money, etc. due to the significant down time. As a result, system purges may be rarely performed, allowing sensitive data to be exposed for long periods of time.

Systems, devices, and techniques are presented herein for tracking data locations for improved memory performance. In particular, systems, devices, and techniques are described in which data associated with ranges of logical addresses that have been mapped to each portion of physical memory may be tracked. Further, techniques are presented for performing selective or accelerated purges, based on the tracking information, that may e.g., remove old (e.g., invalid) data from their original memory locations. Some or all of the logical address space may be partitioned into ranges (e.g., partitions) of logical addresses. A group (e.g., a bitmap) of designators (e.g., bits) may be provided for each physical partition (e.g., a block). Each designator of the group may correspond to a respective one of the logical partitions.

In connection with writing data to a physical partition, the memory system may determine the logical partition associated with the data and may set the designator corresponding to the logical partition in the group associated with the physical partition. The designator may stay set until the physical partition is erased so that the logical partition associated with the data, even invalid data, may be tracked. Then, the memory system may receive a command (e.g., from a host device) to perform a purge on physical partitions containing data associated with a particular logical partition. The memory system may determine the affected physical partitions (e.g., those containing data associated with the particular logical partition) based on the designator corresponding to the logical partition being set in the respective groups and perform the purge on those memory locations, either refraining from purging other memory locations or delaying purging other memory locations until after the affected physical partitions have been purged. Allowing purges to be performed to remove selective data may provide security benefits, latency benefits, efficiency benefits, or a combination thereof, among other possible benefits.

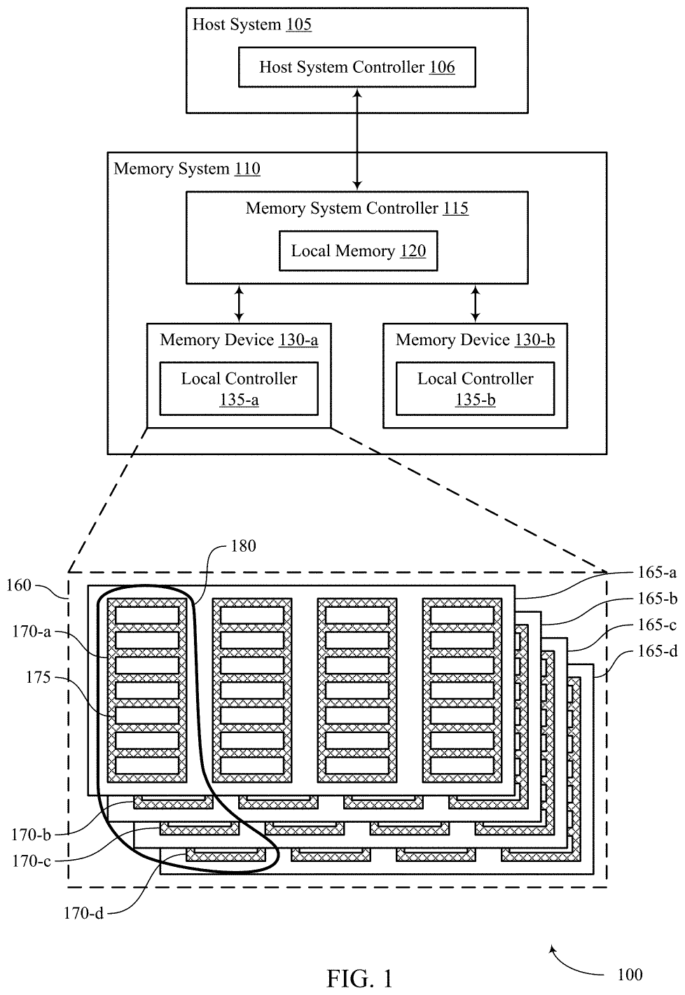

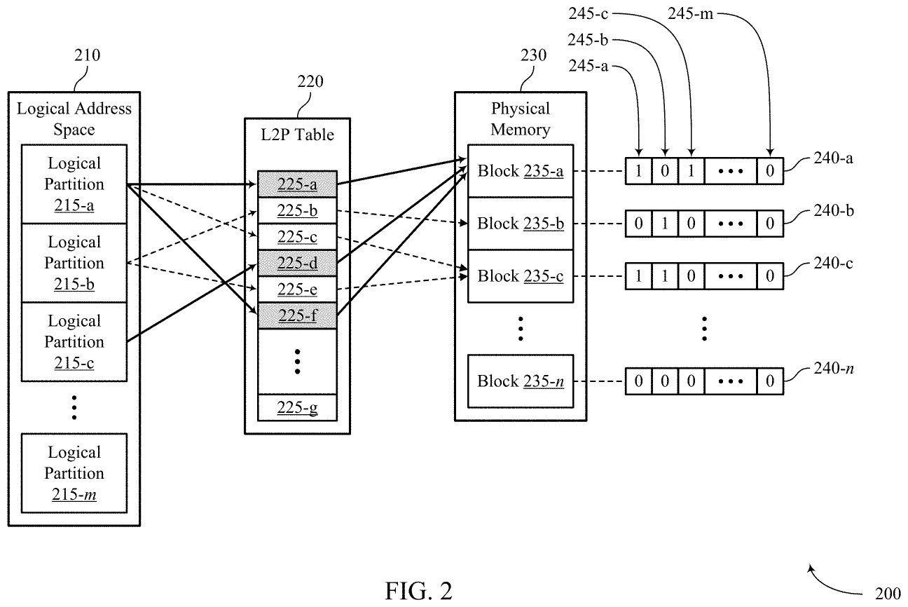

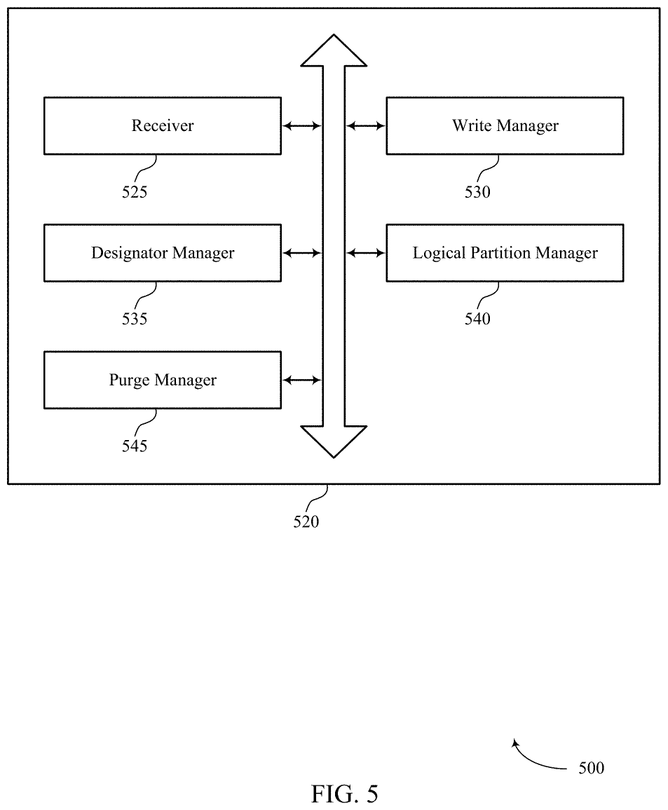

Features of the disclosure are initially described in the context of a system with reference to FIG. 1. Features of the disclosure are further described in the context of a block diagram and flowcharts with reference to FIGS. 2-4. These and other features of the disclosure are further illustrated by and described in the context of an apparatus diagram and flowcharts that relate to tracking data locations for improved memory performance with reference to FIGS. 5-8.

FIG. 1 illustrates an example of a system 100 that supports tracking data locations for improved memory performance in accordance with examples as disclosed herein. The system 100 includes a host system 105 coupled with a memory system 110.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other possibilities.

The system 100 may be included in a computing device such as a desktop computer, a laptop computer, a network server, a mobile device, a vehicle (e.g., airplane, drone, train, automobile, or other conveyance), an Internet of Things (IoT) enabled device, an embedded computer (e.g., one included in a vehicle, industrial equipment, or a networked commercial device), or any other computing device that includes memory and a processing device.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices, and in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130. In some cases, the memory system controller 115 may perform one or more of the operations associated with the example methods discussed herein. For example, the memory system controller may perform a selective purge of physical partitions as discussed herein.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally or alternatively include static random-access memory (SRAM) or other memory that may be used by the memory system controller 115 for internal storage or calculations, for example, related to the functions ascribed herein to the memory system controller 115. Additionally or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally or alternatively rely upon an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, instead be performed by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (RAM) (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on a same die or within a same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b. In some cases, the local controller 135 may perform one or more of the operations associated with the example methods discussed herein. For example, a local controller 135 may perform a selective purge of physical partitions on a respective memory device 130 as discussed herein.

In some cases, a memory device 130 may be or include a NAND device (e.g., NAND flash device). A memory device 130 may be or include a memory die 160. For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170, and in some cases, concurrent operations may take place within different planes 165. For example, concurrent operations may be performed on memory cells within different blocks 170 so long as the different blocks 170 are in different planes 165. That is, concurrent operations may, in some cases, be performed on equivalent blocks in different planes 165. For example, concurrent operations may be performed on blocks 170-a, 170-b, 170-c, and 170-c that are on planes 165-a, 165-b, 165-c, and 165-c, respectively. Such blocks may be collectively referred to as ‘virtual’ blocks. For example, blocks 170-a, 170-b, 170-c, and 170-c may be referred to as a virtual block 180. In some cases the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective blocks 170 and planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in a same page 175 may share (e.g., be coupled with) a common word line, and memory cells in a same string may share (e.g., be coupled with) a common digit line (which may alternatively be referred to as a bit line).

For some NAND architectures, memory cells may be read and programmed (e.g., written) at a first level of granularity (e.g., at the page level of granularity) but may be erased at a second level of granularity (e.g., at the block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

Different sets of data may be associated with different logical addresses within a logical address space, which may alternatively be referred to as a system address space or virtual address space, and which may be referenced by the host system 105 to identify the different sets of data (e.g., read or write commands from the host system 105 may indicate a corresponding set of data based on the logical address for the corresponding set of data). Thus, in some cases, each block 170 of memory cells may be configured to store a set of data corresponding to a respective logical address (e.g., LBA). Additionally, each page 175 may be configured to store a respective set of data associated with one or more logical addresses (e.g., within a logical address space referenced by or otherwise associated with a host system).

In some cases, a memory device 130 may maintain a logical-to-physical (L2P) table to indicate a mapping between the physical address space and the logical address space corresponding to the logical addresses. For example, the L2P table may indicate a physical address for a block 170 or page 175 in which data associated with each logical address is stored. In some cases, one or more copies of an L2P table may be stored within the memory cells of the memory device 130 (e.g., within one or more blocks 170 or planes 165) for use (e.g., reference and updating) by a controller (e.g., the local controller 135 or the memory system controller 115).

In some cases, to update data associated with an LBA and previously written to a first block 170, a new (e.g. updated) version of the data may be written to one or more unused pages of a second block 170. The memory device 130 (e.g., the local controller 135) or the memory system controller 115 may mark or otherwise designate the prior (e.g., outdated) data that remains in the first block 170 (e.g., the prior data) as invalid or obsolete and may update the L2P table to associate the logical address (e.g., LBA) for the data with the new, second block 170 rather than the old, first block 170. The prior (e.g., outdated) version of the data stored at the first block 170 may remain in the first block 170.

In some cases, L2P tables may be maintained and data may be marked as valid or invalid at the page level of granularity, and a page 175 may contain valid data, invalid data, or no data. Generally, invalid data may be data that is outdated due to a more recent or updated version of the data being stored in a different page 175 of the memory device 130. Invalid data may have been previously programmed to the invalid page 175 but may no longer be associated with a valid logical address, such as a logical address referenced by the host system 105. Valid data may be the most recent version of such data being stored on the memory device 130. A page 175 that includes no data may be a page 175 that has never been written to or that has been erased.

In some cases, a memory system controller 115 or a local controller 135 may perform operations (e.g., as part of one or more media management algorithms) for a memory device 130, such as wear leveling, background refresh, garbage collection, scrub, block scans, health monitoring, or others, or any combination thereof. For example, within a memory device 130, a block 170 may have some pages 175 containing valid data and some pages 175 containing invalid data. To avoid waiting for all of the pages 175 in the block 170 to have invalid data before erasing and reusing the block 170, an algorithm referred to as “garbage collection” may be invoked to allow the block 170 to be erased and released as a free block for subsequent write operations. Garbage collection may refer to a set of media management operations that include, for example, selecting a block 170 that contains valid and invalid data, selecting pages 175 in the block that contain valid data, copying the valid data from the selected pages 175 to new locations (e.g., free pages 175 in another block 170), marking the data in the previously selected pages 175 as invalid, and erasing the selected block 170. As a result of garbage collection, the quantity of blocks 170 that have been erased may be increased such that more blocks 170 are available to store subsequent data (e.g., data subsequently received from the host system 105).

The system 100 may include any quantity of non-transitory computer readable media that support tracking data locations for improved memory performance. For example, the host system 105, the memory system controller 115, or a memory device 130 may include or otherwise may access one or more non-transitory computer readable media storing instructions (e.g., firmware) for performing the functions ascribed herein to the host system 105, memory system controller 115, or memory device 130. For example, such instructions, if executed by the host system 105 (e.g., by the host system controller 106), by the memory system controller 115, or by a memory device 130 (e.g., by a local controller 135), may cause the host system 105, memory system controller 115, or memory device 130 to perform one or more associated functions as described herein.

FIG. 2 illustrates an example of a block diagram 200 that supports tracking data locations for improved memory performance in accordance with examples as disclosed herein. The block diagram 200 may illustrate an example relationship between data associated with a logical address space 210 and stored at a physical memory 230 using an L2P table 220 and a plurality of bitmaps 240 (e.g., bitmaps 240-a, 240-b, 240-c, and 240-d) to track the data. The block diagram 200 may implement aspects of the system as described with reference to FIG. 1. For example, a memory system, as described with reference to FIG. 1, may include the logical address space 210, the L2P table 220, the physical memory 230, and the bitmaps 240. In some examples, the components may be used to perform methods (e.g., methods 300 and 400) as disclosed herein.

Using the features depicted in FIG. 2, ranges of logical addresses that have been mapped to each portion of physical memory may be tracked. Further, selective purges, based on the tracking information, may be performed that may e.g., remove old (e.g., outdated or invalid) data from old memory locations.

Within a memory system, sets of data may be associated with logical addresses (e.g., LBAs) within a logical address space 210. The logical addresses may be referenced by a host device to identify the sets of data (e.g., read or write commands from a host device may indicate a corresponding set of data based on the logical address for the corresponding set of data). Some or all of the logical address space 210 may be partitioned into one or more logical partitions 215 (e.g., logical partitions 215-a, 215-b, 215-c, and 215-m). Each logical partition 215 may include a range of logical addresses. In some cases, the logical partitions 215, taken together, may include all of the logical addresses within the logical address space 210 so that each logical address may be included within at least one of the logical partitions 215. In some cases, the logical partitions 215 may abut one another so that each logical address may be included within a single logical partition 215. In some cases, two or more logical partitions 215 may overlap so that one or more logical addresses may be included within more than one logical partition.

In some cases, a portion of the overall logical address space 210 may be partitioned. In those cases, the partitions 215, taken together, may include a subset of the logical addresses within the logical address space 210 so that some logical addresses may not be included in any of the partitions 215. In some cases, the subset of the logical addresses may comprise a relatively small portion of the overall logical address space 210. For example, in some cases, one, two, eight, or the like, small logical partitions 215 may be associated with “special” or “secure” data. These small logical partitions 215 may be subject to selective or accelerated purging for removing sensitive data so the data associated with those logical partitions 215 may be easily tracked. Because these logical partitions 215 may in some cases collectively be a relatively small portion of the overall logical address space 210, a large amount of data (e.g., data associated with logical addresses not in the logical partitions 215) may in some cases not be tracked for selective or accelerated purge purposes.

In some cases, one or more of the logical partitions 215 may be used for tracking and removing security information. For example, a logical partition 215 may be configured to align with a Replay Protected Memory Block (RPMB). In some memory systems, data written to and read from an RPMB may be authenticated (using an HMAC signature and a secret shared key) to prevent tampering. Some systems may store in the RPMB block cryptographic keys used for secure communication or other purposes. When those keys or other secure data stored within the RPMB are no longer valid, a selective or accelerated purge associated with the logical partition, as disclosed herein, may be performed to physically erase the outdated information, for example to prevent the information from being used to attack the security system.

In some cases, a size and/or quantity of the logical partitions 215 may be fixed. That is, the size of the logical partitions 215 or the quantity of the logical partitions 215 or both within a memory system may be predefined or preconfigured. In some other cases, the size or quantity of each logical partition 215 may be dynamic. For example, a host device may signal, to the memory system, an updated size and/or quantity of the logical partitions 215. In some cases, a host device may signal, to the memory system, a starting logical address and an ending logical address for each logical partition. In some cases, each logical partition may correspond to a logical unit (LUN)

The sizes (e.g., ranges) of the logical partitions 215 may vary. For example, a logical partition may include a single logical address or may include any other quantity of logical addresses (e.g., 64 logical addresses or 6000 logical addresses). The sizes of the logical partitions 215 may be equal to one another or may differ from each other. Further, although the block diagram 200 illustrates the logical address space 210 partitioned into four logical partitions 215-a, 215-b, 215-c, and 215-m, the logical address space 210 may be partitioned into any quantity of logical partitions 215.

The quantities and sizes of the logical partitions 215 may be configurable, either as part of the design of the memory system, or as a configurable parameter of the memory system that may be configured either post-manufacture (e.g., based on one or more fuse settings) or dynamically (e.g., during run-time or as part of an initialization procedure, such as by a host device for the memory system). Thus, different memory systems may utilize different quantities and sizes for the logical partitions 215, or a same memory system may utilize different quantities and sizes for the logical partitions 215 at different times. Further, in some cases, different logical partitions 215 may concurrently have different sizes even within the same memory system. For example, a first logical partition 215 may cover a first quantity of logical addresses and a second logical partition 215 may cover a second quantity of logical addresses (e.g., have a second size).

The physical memory 230 may include a plurality of blocks 235 (e.g., blocks 235-a, 235-b, 235-c, and 235-n). Blocks 235 may be examples of blocks 170 or virtual blocks 180 discussed with reference to FIG. 1. Each block 235 may store sets of data. In some cases, each block 235 may include groups of memory cells (e.g., pages 175), each having a respective physical address (e.g., a PBA) and each configured to store a respective set of data corresponding to one or more logical addresses (e.g., an LBA). Although the block diagram 200 illustrates the physical memory 230 having four blocks 235-a, 235-b, 235-c, and 235-n, the physical memory 230 may include any quantity of blocks 235.

The L2P table 220 may indicate mapping between the logical addresses (e.g., associated with a host device) and the physical addresses (e.g., associated with pages of the blocks 235). That is, the L2P table 220 may indicate, for each set of data, the logical address and the physical address of the memory cells in which the data corresponding to the logical address is stored. The L2P table 220 may be an example of an L2P table discussed with reference to FIG. 1. In some cases, the L2P table 220 may be an ordered list of physical addresses (e.g., PBAs), where each position 225 (e.g., 225-a through 225-g) within the L2P table 220 may correspond to a respective logical address (e.g., LBA), and thus a physical address being listed in a particular position 225 within the L2P table 220 may indicate that data associated with the logical address corresponding to the position is stored at memory cells having the listed physical address. In some cases, each position 225 of the L2P table 220 may be a row that includes entries for a physical address (e.g., a PBA) and a logical address (e.g., LBA), and thus a physical address being listed with a logical address in a row 225 within the L2P table 220 may indicate that data associated with the logical address is stored at memory cells having the listed physical address. Although the block diagram 200 illustrates the L2P table 220 having seven positions 225, the L2P table 220 may include any quantity of positions 225.

For each block 235, a memory system may indicate an associated bitmap 240. For example, bitmap 240-a may be associated with block 235-a, bitmap 240-b may be associated with block 235-b, bitmap 240-c may be associated with block 235-c, and bitmap 240-n may be associated with block 235-n. Thus, although the block diagram 200 illustrates four bitmaps 240-a, 240-b, 240-c, and 240-n, the memory system may include any quantity of bitmaps 240, equal to the quantity of blocks 235. Each bitmap 240 may indicate whether data associated with any particular logical partition 215 (e.g., within the range of logical addresses corresponding to the logical partition) has been written to the corresponding block 235.

Each bitmap 240 may include a set of bits 245 (e.g., bits 245-a, 245-b, 245-c, and 245-m), each corresponding to a respective logical partition 215. For example, bit 245-a in each bitmap 240 may correspond to logical partition 215-a, bit 245-b in each bitmap 240 may correspond to logical partition 215-b, bit 245-c in each bitmap 240 may correspond to logical partition 215-c, and bit 245-n in each bitmap 240 may correspond to logical partition 215-n. Thus, although the block diagram 200 illustrates four bits 245-a, 245-b, 245-c, and 245-m, in each bitmap, each bitmap 240 may include any quantity of bits 245, equal to the quantity of logical partitions 215. That is, as a quantity of the logical partitions 215 increases, the quantity of bits 245 of bitmaps 240 correspondingly may increase. Additionally, as the quantity of the logical partitions 215 decreases, the quantity of bits 245 correspondingly may decrease.

For each bitmap 240, the value of each bit 245 may indicate whether the block 235 has stored thereon any data associated with the logical partition 215 corresponding to the particular bit 245. For example, bit 245-a of the bitmap 240-a may be “set” (e.g., may store a value (e.g., a logic value ‘1’)) indicating that block 235-a has stored thereon data associated with at least one logical address that is within logical partition 215-a. Conversely, for example, bit 245-b may not be set (e.g., may store a different value (e.g., a logic value ‘0’)) indicating that block 235-b does not have stored thereon data associated with any logical address that is within logical partition 215-b.

In some cases, the memory system may update a bitmap 240 in connection with writing data to a corresponding block 235. For example, in connection with storing data in a block 235, the memory system may update the bitmap 240 corresponding to the block 235 to indicate that the data written to the block is associated with a particular logical partition 215. For example, in connection with writing data associated with a logical address within logical partition 215-a to block 235-a, the memory system may update the corresponding bitmap 240-a by setting the bit 245-a corresponding to logical partition 215-a to a value (e.g., ‘1’) indicating that the data written to block 235-a is associated with logical partition 215-a.

Regardless of the size or quantity of the logical partitions 215 used for the logical address space 210, the memory system may use a respective bitmap 240 for each block 235, including a respective bit 245 corresponding to each of the logical partitions 215. Thus, the size of each bitmap 240 may be based on the quantity of logical partitions 215 used for the logical address space 210. The configurable size for each of the logical partitions 215 may allow an overhead associated with garbage collection operations performed by the memory system to be tunable (e.g., adjustable, configurable) based on configuring the size of the individual logical partitions 215 (e.g., whether the logical address space 210 is divided into relatively many small logical partitions 215, or relatively few large logical partitions 215), among other benefits that may be appreciated by one of ordinary skill in the art.

In some cases, the bitmaps 240 may be stored within the memory cells of the memory device 130. In some cases, each bitmap 240 may be stored within the respective block 235 associated therewith. In some cases, the bitmaps may be stored in a central location within the physical memory.

In the example of block diagram 200, six sets of data have been written to physical memory 230 by the memory system. The memory system has mapped the data from logical partitions 215 to blocks 235 and stored the mappings in positions 225-a through 225-f of the L2P table 220, as depicted. Sets of data associated with logical partitions 215-a and 215-c have been written to block 235-a. Accordingly, the memory system has set bits 245-a and 245-c, which correspond to logical partitions 215-a and 215-c, in bitmap 240-a, which is associated with block 235-a. A set of data associated with logical partition 215-b has been written to block 235-b. Accordingly, the memory system has set bit 245-b, which corresponds to logical partition 215-b, in bitmap 240-b, which is associated with block 235-b. Sets of data associated with logical partitions 215-a and 215-b have been written to block 235-c. Accordingly, the memory system has set bits 245-a and 245-b, which correspond to logical partitions 215-a and 215-b, in bitmap 240-c, which is associated with block 235-b. Sets of data associated with logical partitions 215-a and 215-b have been written to block 235-c. No sets of data associated with any of the logical partitions 215 have been written to block 235-n, so no bits 245 are set in corresponding bitmap 240-n.

The tracking of logical partitions to blocks may allow selective purges to be performed. For example, the memory system may receive a command (e.g., from a host device) to perform a purge of blocks 235 containing data associated with a particular logical partition 215 (e.g., a logical partition associated with sensitive information). The memory system may identify the affected blocks 235 based on the values of the bits 245 corresponding to the logical partition 215 being set in the respective bitmaps 240. This may include blocks 235 having outdated or invalid data. The memory system may perform the purge on those blocks 235 to remove the data. Accordingly, data (e.g., sensitive information) associated with the logical partition 215 may be removed from physical memory by performing a selective purge instead of a complete system purge.

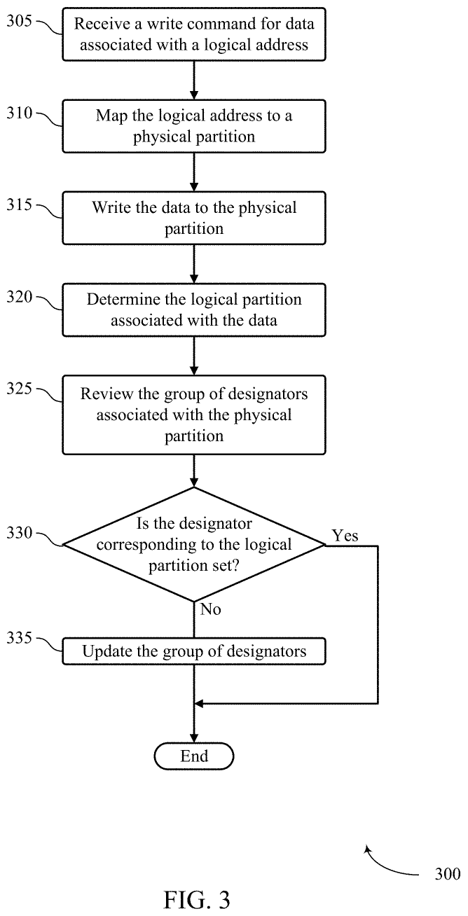

FIG. 3 shows a flow chart illustrating a method 300 that supports tracking data locations for improved memory performance in accordance with examples as disclosed herein. The operations of method 300 may be implemented by a memory system or its components as described herein. For example, aspects of the method 300 may be implemented by a controller, among other components. Additionally or alternatively, aspects of the method 300 may be implemented as instructions stored in memory (e.g., firmware stored in a memory coupled with a memory device). For example, the instructions, upon execution by a controller (e.g., controller 135), may cause the controller to perform the operations of the method 300. In some examples, a memory system may execute a set of instructions to control the functional elements of the memory system to perform the described functions. Additionally or alternatively, a memory system may perform aspects of the described functions using special-purpose hardware. The method 300 will be discussed with reference to the components depicted in FIG. 2.

Using method 300, logical partitions associated with sets of data may be determined and the logical partitions mapped to each physical partition may be tracked. In connection with writing data to a physical partition, the memory system may determine the logical partition associated with the data and may set the designator corresponding to the logical partition, if it is not already set, in the group of designators associated with the physical partition.

At 305, a write command may be received by a memory system (e.g., from a host device) for a set of data. The set of data may be associated with a logical address (e.g., an LBA within a logical address space associated with a host device).

At 310, the logical address associated with the data may be mapped to an available physical partition. For example, the memory system may identify an available page of a block or a virtual block and may map an LBA associated with the data to the block or virtual block, as generally discussed with reference to FIG. 2. The memory system may update the L2P table to indicate the mapping of the logical address to the physical partition. Referring to the example in FIG. 2, the memory system may map the LBA associated with the set of data to block 235-a and may store the mapping in position 225-a of L2P table 220.

At 315, the set of data associated with the logical address may be written to the physical partition to which the logical address has been mapped. For example, the memory system may write the set of data to the page of the block or virtual block determined in 310 and associated with the LBA in the L2P table, as generally discussed with reference to FIG. 2. Referring again to the example in FIG. 2, the memory system may write the set of data to block 235-a.

At 320, a portion of the logical address space that includes the logical address associated with the set of data may be identified. A portion or all of the logical address space may be partitioned into one or more portions (logical partitions), each including one or more logical addresses. At 320, the memory system may identify which, if any, of the logical partitions includes the logical address associated with the data written to the physical partition. In some cases, the logical partitions may overlap so that some logical addresses may be included within more than one logical partition. If the logical address associated with the data is included in more than one logical partition, the memory system may identify the logical partitions that include the logical address. In some cases, the logical address may not be included in any of the logical partitions. Referring again to the example in FIG. 2, the memory system may determine that the LBA associated with the data falls within the range associated with logical partition 215-a.

At 325, assuming that the logical address is included in a logical partition, a group of designators associated with the physical partition may be reviewed. Each designator may correspond to a respective logical partition. The memory system may review the group of designators to determine whether the particular designator corresponding to the logical partition determined at 320 is set. In some cases, the group of designators may comprise a bitmap and each designator may be a bit within the bitmap. For example, referring again to the example in FIG. 2, since data associated with logical partition 215-a has been written to block 235-a, the bitmap 240-a, which is associated with block 235-a, may be reviewed to determine whether the bit 245-a, which corresponds to logical partition 215-a, has been set. If more than one logical partition was determined at 320, the designators corresponding to each logical partition determined at 320 may be reviewed.

At 330, it may be ensured that the designator corresponding to the logical partition is set. The designator corresponding to the logical partition may be evaluated. If the designator corresponding to the logical partition is not set, the method may continue to 335 to update the group of designators corresponding to the physical partition. Otherwise, the designator corresponding to the logical partition may already be set and the method may bypass 335.

At 335, the group of designators corresponding to the physical partition may be updated. The memory system may update the group of designators to reflect that data associated with the logical partition has been written to the physical partition. To do this, the memory system may, in the group of designators associated with the physical partition, set the designator corresponding to the logical partition identified at 320. For example, the memory system may set a bit of a bitmap associated with the physical partition, if the bit has not already been set, as generally discussed with reference to FIG. 2. Referring again to the example in FIG. 2, if the bit 245-a corresponding to the first logical partition 215-a has not been set, the memory system may set the bit. If more than one logical partition was identified at 320, the memory system may set the designators (e.g., bits) corresponding to each of the identified logical partitions.

The method described above describes one possible implementation. The operations and steps may be rearranged or otherwise modified and other implementations are possible. For example, although step 320 is shown being performed after steps 315 and 310, step 320 may, in some cases, be performed before step 315 or before step 310.

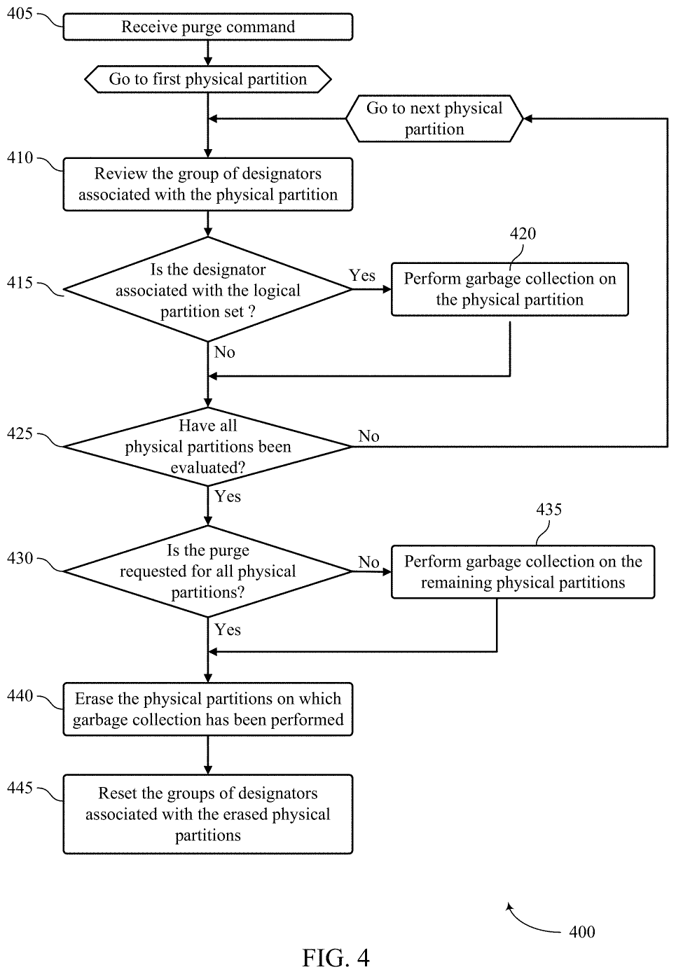

FIG. 4 shows a flow chart illustrating a method 400 that supports tracking data locations for improved memory performance in accordance with examples as disclosed herein. The operations of method 400 may be implemented by a memory system or its components as described herein. For example, aspects of the method 400 may be implemented by a controller, among other components. Additionally or alternatively, aspects of the method 400 may be implemented as instructions stored in memory (e.g., firmware stored in a memory coupled with a memory device). For example, the instructions, upon execution by a controller (e.g., controller 405), may cause the controller to perform the operations of the method 400. In some examples, a memory system may execute a set of instructions to control the functional elements of the memory system to perform the described functions. Additionally or alternatively, a memory system may perform aspects of the described functions using special-purpose hardware. The method 400 will be discussed with reference to the components shown on FIG. 2.

Using method 400, selective purging of physical partitions may be performed based on the logical addresses associated with data stored on the physical partitions. The memory system may receive a purge command (e.g., a selective purge command), such as from a host device), and in response may perform a purge on physical partitions containing data associated with a particular logical partition, in either selective or accelerated fashion. The memory system may determine the affected physical partitions based on the designator corresponding to the logical partition being set in the respective groups of designators and perform the selective purge on those physical partitions.

At 405, a purge command may be received by the memory system (e.g., from a host device). The purge command may identify one or more logical partitions to associate with the purge. For example, using FIG. 2. as an example, the memory system may receive a purge command that identifies logical partition 215-a. This may mean that physical partitions having data associated with the identified logical partitions are to be erased. In some cases, the purge command may also include an indication of the breadth of purge to perform. For example, the purge command may indicate whether to perform a purge on physical partitions associated with the identified one or more logical partitions, or also on the remaining physical partitions.

In some cases, a memory system may support multiple types of purge commands. A first type of purge command may indicate (e.g., via one or more fields of the purge command) one or more logical partitions to associate with the purge, as noted above and elsewhere herein. The memory system may, in response to such a purge command, purge those physical partitions storing data associated with the indicated one or more logical partitions in selective fashion (e.g., refraining from purging one or more other physical partitions) or accelerated fashion (e.g., purging one or more other physical partitions after having purged those physical partitions storing data associated with the indicated one or more logical partitions). In some cases, a purge command of the first type may include a field indicating whether the memory system is to perform the responsive purge in selective or accelerated fashion.

Alternatively, different purge command types may be used for selective versus accelerated purges (e.g., a first purge command type for selective, a second purge command type for accelerated). And additionally, a purge command may in some cases may not indicate any particular one or more logical partitions to associate with the purge, but the purge command may be of a type associated with a selective or accelerated purge operation, and the memory system may in response thereto perform the commanded selective or accelerated purge operation treating any logical partition subject to data location tracking as described herein (e.g., any logical partition for which associated designators are maintained) as a logical partition for which data is to be purged in selective or accelerated fashion.

In some cases, another type of purge command may not identify any particular logical partitions to associate with the purge. In response to such a purge command, the memory system may perform a purge without regard to which physical partitions store data associated with any of the set of tracked logical partitions, or the memory system may perform a purge in accelerated fashion (e.g., as a matter of default configuration) on those physical partitions that store data associated with any of the set of tracked logical partitions.

Upon receipt of a purge command in response to which a selective or accelerated purge is to be performed, each physical partition, one by one, may be reviewed (e.g., by the memory system) to determine which ones to purge. Each review may encompass steps 410, 415, and, for the physical partitions determined to be purged, 420.

At 410, the group of designators associated with the physical partition may be reviewed to determine whether the physical partition should be purged. For example, a bitmap associated with the block or virtual block may be reviewed, as generally discussed with reference to FIG. 2. Each designator of the group may correspond to a respective logical partition. One or more of the designators may have been set in connection with writing data to the physical partition, e.g., using method 300. For example, with reference to FIG. 2, the memory system may have set one or more bits 245 of the bitmaps 240 associated with the blocks 235.

During the review, the memory system may determine whether a designator associated with the one or more logical partitions identified at 405 are set. Initially (e.g., in connection with entering 410 from 405), the group of designators associated with the first physical partition may be reviewed. Thereafter (e.g., in connection with entering 410 from 425), the group of designators associated with the next physical partition may be reviewed. For example, in the example of FIG. 2, the memory system may initially review the bits 245 of bitmap 240-a associated with the first block 235-a and then review the bits 245 of bitmaps 240-b, 240-c in turn as step 410 is subsequently performed.

At 415, it may be determined whether a designator associated with any of the identified logical partitions is set. If so, it may signify that the physical partition has data stored thereon that is associated with at least one of the one or more identified logical partitions and the method may continue to 420 to perform garbage collection on the physical partition. If no designators associated with any of the identified logical partitions are set, it may signify that the physical partition does not have any data stored thereon that is associated with the identified logical partitions. As such, garbage collection may not be performed on the physical partition and the method may bypass 420. For example, in the example of FIG. 2, the memory system may determine at 415 that corresponding bit 245-a of bitmap 240-a is set for block 235-a and the method would continue to 420 to purge block 235-a. The next time 415 is performed, the memory system may determine that bit 245-a of bitmap 240-b is not set for block 235-b and the method would bypass 420 and not purge block 235-b.

At 420, if the physical partition is associated with the identified one or more logical partitions, a garbage collection may be performed on the physical partition. As generally discussed with reference to FIG. 1, this may include, for example, selecting portions (e.g., pages) of the physical partition that contain valid data, copying the valid data from the selected portions to new locations (e.g., free portions in another physical partition), and marking the data in the previously selected portions as invalid. Upon completion of the garbage collection of the physical partition, the method may continue to 425.

At 425, it may be determined whether the review of the physical partitions has been completed. If it has, then garbage collection may have been performed on the physical partitions that have had data stored thereon corresponding to the identified one or more logical partitions. For example, in the example of FIG. 2, the memory system may have performed garbage recovery on blocks 235-a and 235-c based on bit 245-a being set in bitmaps 240-a and 240-c, respectively. Once the review of the physical partitions has been completed, the method may continue to 430 to determine if more garbage collections may be performed. If the review has not been completed (e.g., one or more physical partitions have yet to be reviewed), the method may return to 410 to review the group of designators associated with the next physical partition.

At 430, it may be determined whether to perform purges on the rest of the physical partitions (e.g., the physical partitions that are not associated with the identified one or more logical partitions). If the purge command included an indication to perform purges on the remainder of the physical partitions (or the purge command otherwise commanded that an accelerated purge be performed), the method may continue to 435 to perform garbage collection on the rest of the physical partitions. If no such indication was received with the purge command (or the purge command otherwise commanded that a selective purge be performed), step 435 may be bypassed and the method may continue to 440.

At 435, a garbage collection may be performed on each of the remaining physical partitions (e.g., the physical partitions that are not associated with the identified one or more logical partitions and have therefore not had garbage collection performed). For example, in the example of FIG. 2, the memory system may perform garbage collection on blocks 235-b and 235-n, since garbage collection was not performed previously on them. Note that garbage collection of the physical partitions associated with the identified one or more logical partitions may be performed first, before garbage collection of the rest of the physical partitions. Upon completion of the garbage collections of the physical partitions, the method may continue to 440.

At 440, the physical partitions that have had garbage collection performed on them may be erased. In some cases, this may include the physical partitions associated with the identified one or more logical partitions. In some cases, this may include all of the physical partitions. For example, in the example of FIG. 2, the memory system may erase blocks 235-a and 235-c and possibly blocks 235-b and 235-n.

At 445, the groups of designators associated with the erased physical partitions may be reset (e.g., the bits of the bitmaps may be set to ‘0’) to reflect that because the physical partitions have been erased, no data is stored on the physical partition that is associated with any of the logical partitions. For example, in the example of FIG. 2, the memory system may reset bitmaps 240-a and 240-c associated with blocks 235-a and 235-c, respectively, so that the bits therein are not set. If blocks 235-b and 235-n have been erased, the memory system may also reset associated bitmaps 240-b and 240-d.

The method described above describes one possible implementation. The operations and steps may be rearranged or otherwise modified and other implementations are possible. For example, in some cases, steps 430 and 435 may be omitted so that step 425 may continue directly to step 440 upon completion of the review of the physical partitions. The method would then perform garbage collections on the physical partitions that may have had data stored thereon corresponding to the identified one or more logical partitions. The method would not check to see if the purge command included an indication of the breadth of the purge and garbage collection would not be performed on any other physical partitions.

As another example, in some cases, if the received purge command does not identify any logical partitions, the method may bypass steps 410 through 435 and perform garbage collections on all of the physical partitions, then continue directly to step 440 to erase all of the physical partitions. In this manner, a system purge may be effected by omitting the logical partition identification from the purge command.

Selective purging of outdated data may provide many benefits. For example, using a selective purge may ensure that data associated with a logical partition may be erased. Such selective or accelerated purges may be especially useful for removing old (e.g., outdated or invalid) sensitive (e.g., security or personal) information from the memory system. If, e.g., all sensitive (e.g., security or personal) data is associated with a particular logical partition (e.g., by the host device), a selective or accelerated purge associated with that logical partition may remove all of the old sensitive data, leading to less exposure of the sensitive data. For example, if a logical partition aligns with an RPMB, a purge associated with that logical partition may remove all of the outdated RPMB security information. Further, selective purges may be performed more often. Thus, the tracking of logical partitions to physical partitions may provide security benefits, latency benefits, efficiency benefits, or a combination thereof, among other possible benefits.

In some examples, different levels of sensitivity may be assigned to different logical partitions so that a host device may write data to the logical partitions accordingly. For example one logical partition may be associated with highly sensitive data (e.g., fingerprints, passwords, etc.) and another logical partition may be associated with less-sensitive data (e.g., phone numbers, addresses, etc.). The host device may then decide how often to purge memory associated with each of the logical partitions based on the sensitivity level. For example, the logical partition associated with the highest sensitive data may be selectively purged more often than the logical partition associated with the less sensitive data, which may be selectively purged more often then the other logical partitions.

Thus, the tracking of logical partitions to blocks may provide security benefits, latency benefits, efficiency benefits, or a combination thereof, among other possible benefits.

In some examples, methods 300 and 400 may be used in conjunction with each other to determine physical partitions to selectively purge. For example, method 300 may be used to set designators corresponding to logical partitions in connection with writing data associated with the logical partitions to physical partitions and method 400 may be used to selectively purge physical partitions based on which designators are set for each physical partition.

FIG. 5 shows a block diagram 500 of a memory system 520 that supports tracking data locations for improved memory performance in accordance with examples as disclosed herein. The memory system 520 may be an example of aspects of a memory system as described with reference to FIGS. 1 through 4. The memory system 520, or various components thereof, may be an example of means for performing various aspects of tracking data locations for improved memory performance as described herein. For example, the memory system 520 may include a receiver 525, a write manager 530, a designator manager 535, a logical partition manager 540, a purge manager 545, or any combination thereof. Each of these components may communicate, directly or indirectly, with one another (e.g., via one or more buses).

In some examples, the receiver 525 may be configured as or otherwise support a means for receiving a plurality of write commands, each of the plurality of write commands for a respective set of data associated with a respective logical partition of a set of logical partitions, each logical partition of the set of logical partitions corresponding to a respective range of logical addresses. The write manager 530 may be configured as or otherwise support a means for performing a plurality of write operations to write the respective sets of data to a plurality of physical partitions of one or more memory devices based at least in part on the plurality of write commands, where each physical partition of the plurality of physical partitions is associated with a respective group of designators, and where each designator of the respective group of designators corresponds to a respective logical partition of the set of logical partitions. The designator manager 535 may be configured as or otherwise support a means for updating, for each physical partition of the plurality of physical partitions, the respective group of designators to indicate, for each logical partition of the set of logical partitions, whether data associated with the logical partition has been written to the physical partition based at least in part on the plurality of write operations.

In some examples, the logical partition manager 540 may be configured as or otherwise support a means for determining, based at least in part on performing each write operation of the plurality of write operations, whether the respective set of data associated with the write operation corresponds to any logical partition of the set of logical partitions, where the updating is based at least in part on determining whether the respective set of data corresponds to any logical partition of the set of logical partitions.

In some examples, to support updating the respective group of designators associated with each physical partition, the logical partition manager 540 may be configured as or otherwise support, for each write operation of the plurality of write operations, a means for determining a logical partition of the set of logical partitions associated with the respective set of data associated with the write operation. In some examples, to support tracking data locations for improved memory performance, the designator manager 535 may be configured as or otherwise support, for each write operation of the plurality of write operations, a means for setting, within the respective group of designators associated with the physical partition to which the respective set of data is written, a designator corresponding to the determined logical partition.

In some examples, each respective group of designators may be stored in the physical partition associated therewith.

In some examples, the receiver 525 may be configured as or otherwise support a means for receiving a command to purge data associated with one or more logical partitions of the set of logical partitions. In some examples, the purge manager 545 may be configured as or otherwise support a means for performing (e.g., in response to the command to purge data associated with the one or more logical partitions) garbage collection on each physical partition of the plurality of physical partitions to which data associated with the one or more logical partitions has been written.

In some examples, to support performing the garbage collection, the logical partition manager 540 may be configured as or otherwise support, for each physical partition of the plurality of physical partitions, a means for determining whether data associated with the one or more logical partitions has been written to the physical partition. In some examples, to support performing the garbage collection, the purge manager 545 may be configured as or otherwise support, for each physical partition of the plurality of physical partitions, a means for performing garbage collection on the physical partition responsive to the logical partition manager 540 determining that data associated with the one or more logical partitions has been written to the physical partition.

In some examples, the logical partition manager 540 may be configured as or otherwise support a means for determining, based at least in part on the command to purge data associated with the one or more logical partitions, one or more physical partitions of the plurality of physical partitions to which data associated with the one or more logical partitions has been written, where performing the garbage collection is based at least in part on determining the one or more physical partitions to which data associated with the one or more logical partitions has been written.

In some examples, to support performing the garbage collection, the designator manager 535 may be configured as or otherwise support, for each physical partition of the plurality of physical partitions, a means for evaluating the respective group of designators associated with the physical partition. In some examples, to support tracking data locations for improved memory performance, the logical partition manager 540 may be configured as or otherwise support, for each physical partition of the plurality of physical partitions, a means for determining, for each of the one or more logical partitions, whether data associated with the logical partition has been written to the physical partition based at least in part on a value of the designator respectively corresponding to the logical partition.

In some examples, the purge manager 545 may be configured as or otherwise support a means for refraining from performing garbage collection on each physical partition of the plurality of physical partitions to which data associated with the one or more logical partitions has not been written.

In some examples, the purge manager 545 may be configured as or otherwise support a means for performing, after performing the garbage collection on the physical partitions to which data associated with the one or more logical partitions has been written, garbage collection on each physical partition of the plurality of physical partitions to which data associated with the one or more logical partitions has not been written.

In some examples, the purge manager 545 may be configured as or otherwise support a means for erasing each physical partition on which the garbage collection was performed.

In some examples, the receiver 525 may be configured as or otherwise support a means for receiving, from a host device for the one or more memory devices, an indication of the set of logical partitions.

In some examples, the respective group of designators for at least one physical partition of the plurality of physical partitions may be updated before at least one write operation of the plurality of write operations is performed.

In some examples, each respective group of designators may include a bitmap, each bit in the bitmap including a respective designator of the group of designators.

In some examples, to support updating the respective group of designators associated with each physical partition, the designator manager 535 may be configured as or otherwise support a means for, for each physical partition of the plurality of physical partitions, setting a designator within the respective group of designators associated with the physical partition responsive to data associated with the respective logical partition corresponding to the designator being written to the physical partition.

In some examples, the receiver 525 may be configured as or otherwise support a means for receiving a plurality of write commands each for a respective set of data associated with a respective logical address. In some examples, the write manager 530 may be configured as or otherwise support a means for performing a plurality of write operations to write the respective sets of data to a plurality of physical partitions of one or more memory devices based at least in part on the plurality of write commands. The logical partition manager 540 may be configured as or otherwise support a means for determining, based at least in part on performing the plurality of write operations, a set of the plurality of physical partitions to which data associated with logical addresses within a range of logical addresses is written. In some examples, the designator manager 535 may be configured as or otherwise support a means for maintaining designators each associated with a respective physical partition of the plurality of physical partitions, the designators indicating the set of physical partitions to which data associated with logical addresses within the range of logical addresses is written.

In some examples, the designator manager 535 may be configured as or otherwise support a means for updating the designators in connection with performing the plurality of write operations. In some examples, to support updating the designators in connection with performing the plurality of write operations, the designator manager 535 may be configured as or otherwise support a means for, for each write operation associated with a physical partition to which data associated with the range of logical addresses is written in connection with the plurality of write operations, setting a bit within a bitmap, where the bit includes a designator associated with the physical partition.

In some examples, the receiver 525 may be configured as or otherwise support a means for receiving a command to purge data associated with the range of logical addresses. In some examples, the purge manager 545 may be configured as or otherwise support a means for performing a garbage collection operation on each physical partition of the set of physical partitions based at least in part on the command to purge the data associated with the range of logical addresses.

In some examples, to support performing the garbage collection operation on each physical partition of the set of physical partitions, the logical partition manager 540 may be configured as or otherwise support, for each physical partition of the set of physical partitions, a means for determining, based at least in part on a designator associated with the physical partition, whether the physical partition stores data associated with the range of logical addresses. In some examples, to support performing the garbage collection operation on each physical partition of the set of physical partitions, the purge manager 545 may be configured as or otherwise support, for each physical partition of the set of physical partitions, a means for performing garbage collection on the physical partition responsive to determining that the physical partition stores data associated with the range of logical addresses.

In some examples, the purge manager 545 may be configured as or otherwise support a means for erasing each physical partition of the set of physical partitions after performing the garbage collection.

In some examples, the logical partition manager 540 may be configured as or otherwise support a means for identifying the set of physical partitions, in response to the command to purge the data associated with the range of logical addresses, based at least in part on the designators.

In some examples, the command to purge the data may indicate the range of logical addresses.

In some examples, the logical partition manager 540 may be configured as or otherwise support a means for determining, based at least in part on performing the plurality of write operations, a second set of the plurality of physical partitions to which data associated with logical addresses within a second range of logical addresses is written, the second range of logical addresses within a same logical address space as the range of logical addresses. In some examples, the designator manager 535 may be configured as or otherwise support a means for maintaining second designators each associated with a respective physical partition of the plurality of physical partitions, the second designators indicating the second set of the plurality of physical partitions to which data associated with logical addresses within the second range of logical addresses is written.

In some examples, the receiver 525 may be configured as or otherwise support a means for receiving a write command for data associated with a logical address. In some examples, the write manager 530 may be configured as or otherwise support a means for writing the data to a physical partition of one or more memory devices based at least in part on the write command. In some examples, the logical partition manager 540 may be configured as or otherwise support a means for determining, based at least in part on writing the data to the physical partition, whether the logical address is within a logical address range. In some examples, the designator manager 535 may be configured as or otherwise support a means for ensuring, based at least in part on determining that the logical address is within the logical address range, that a bit within a bitmap for the physical partition is set, where the bit being set indicates that data corresponding to the logical address range is stored within the physical partition.

In some examples, the receiver 525 may be configured as or otherwise support a means for receiving, after the write command, a purge command. In some examples, the designator manager 535 may be configured as or otherwise support a means for determining, based at least in part on the purge command, whether the bit within the bitmap is set. In some examples, the purge manager 545 may be configured as or otherwise support a means for performing garbage collection on the physical partition based at least in part on determining that the bit within the bitmap is set.

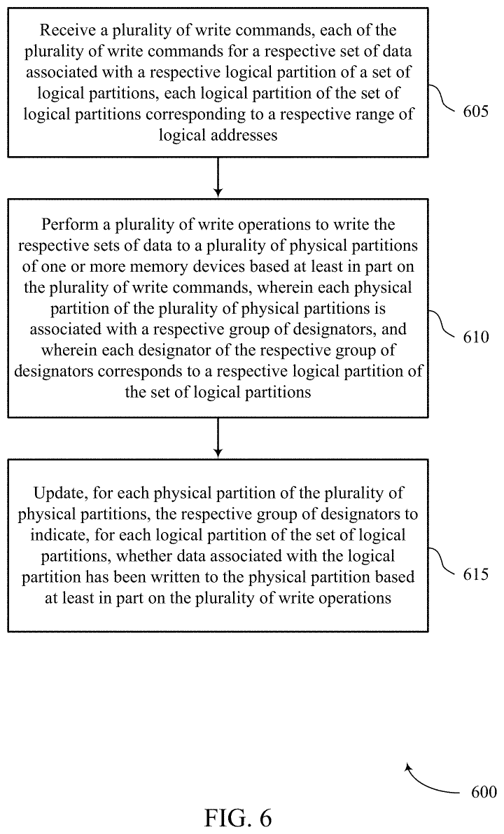

FIG. 6 shows a flowchart illustrating a method 600 that supports tracking data locations for improved memory performance in accordance with examples as disclosed herein. The operations of method 600 may be implemented by a memory system or its components as described herein. For example, the operations of method 600 may be performed by a memory system as described with reference to FIGS. 1 through 5. In some examples, a memory system may execute a set of instructions to control the functional elements of the device to perform the described functions. Additionally or alternatively, the memory system may perform aspects of the described functions using special-purpose hardware.

At 605, the method may include receiving a plurality of write commands, each of the plurality of write commands for a respective set of data associated with a respective logical partition of a set of logical partitions, each logical partition of the set of logical partitions corresponding to a respective range of logical addresses. The operations of 605 may be performed in accordance with examples as disclosed herein. In some examples, aspects of the operations of 605 may be performed by a receiver 525 as described with reference to FIG. 5.

At 610, the method may include performing a plurality of write operations to write the respective sets of data to a plurality of physical partitions of one or more memory devices based at least in part on the plurality of write commands, where each physical partition of the plurality of physical partitions is associated with a respective group of designators, and where each designator of the respective group of designators corresponds to a respective logical partition of the set of logical partitions. The operations of 610 may be performed in accordance with examples as disclosed herein. In some examples, aspects of the operations of 610 may be performed by a write manager 530 as described with reference to FIG. 5.

At 615, the method may include updating, for each physical partition of the plurality of physical partitions, the respective group of designators to indicate, for each logical partition of the set of logical partitions, whether data associated with the logical partition has been written to the physical partition based at least in part on the plurality of write operations. The operations of 615 may be performed in accordance with examples as disclosed herein. In some examples, aspects of the operations of 615 may be performed by a designator manager 535 as described with reference to FIG. 5.

In some examples, an apparatus as described herein may perform a method or methods, such as the method 600. The apparatus may include, features, circuitry, logic, means, or instructions (e.g., a non-transitory computer-readable medium storing instructions executable by a processor) for receiving a plurality of write commands, each of the plurality of write commands for a respective set of data associated with a respective logical partition of a set of logical partitions, each logical partition of the set of logical partitions corresponding to a respective range of logical addresses, performing a plurality of write operations to write the respective sets of data to a plurality of physical partitions of one or more memory devices based at least in part on the plurality of write commands, where each physical partition of the plurality of physical partitions is associated with a respective group of designators, and where each designator of the respective group of designators corresponds to a respective logical partition of the set of logical partitions, and updating, for each physical partition of the plurality of physical partitions, the respective group of designators to indicate, for each logical partition of the set of logical partitions, whether data associated with the logical partition has been written to the physical partition based at least in part on the plurality of write operations.

Some examples of the method 600 and the apparatus described herein may further include operations, features, circuitry, logic, means, or instructions for determining, based at least in part on performing each write operation of the plurality of write operations, whether the respective set of data associated with the write operation corresponds to any logical partition of the set of logical partitions, where the updating may be based at least in part on determining whether the respective set of data corresponds to any logical partition of the set of logical partitions.

In some examples of the method 600 and the apparatus described herein, operations, features, circuitry, logic, means, or instructions for updating the respective set of designators associated with each physical partition may include operations, features, circuitry, logic, means, or instructions for, for each write operation of the plurality of write operations, determining a logical partition of the set of logical partitions corresponding to the respective set of data associated with the write operation and setting, within the respective group of designators for the physical partition to which the respective set of data is written, a designator associated with the determined logical partition.

In some examples of the method 600 and the apparatus described herein, each respective group of designators may be stored in the physical partition associated therewith.

Some examples of the method 600 and the apparatus described herein may further include operations, features, circuitry, logic, means, or instructions for receiving a command to purge data associated with one or more logical partitions of the set of logical partitions and performing garbage collection on each physical partition of the plurality of physical partitions to which data associated with the one or more logical partitions has been written.

In some examples of the method 600 and the apparatus described herein, operations, features, circuitry, logic, means, or instructions for performing the garbage collection may include operations, features, circuitry, logic, means, or instructions for, for each physical partition of the plurality of physical partitions, determining whether data associated with the one or more logical partitions has been written to the physical partition and performing garbage collection on the physical partition responsive to determining that data associated with the one or more logical partitions has been written to the physical partition.

Some examples of the method 600 and the apparatus described herein may further include operations, features, circuitry, logic, means, or instructions for determining, based at least in part on the command to purge data associated with the one or more logical partitions, one or more physical partitions of the plurality of physical partitions to which data associated with the one or more logical partitions has been written, where performing the garbage collection may be based at least in part on determining the one or more physical partitions to which data associated with the one or more logical partitions has been written.

In some examples of the method 600 and the apparatus described herein, operations, features, circuitry, logic, means, or instructions for determining the one or more physical partitions to which data associated with the one or more logical partitions has been written may include operations, features, circuitry, logic, means, or instructions for, for each physical partition of the plurality of physical partitions, evaluating the respective group of designators associated with the physical partition and determining, for each of the one or more logical partitions, whether data associated with the logical partition has been written to the physical partition based at least in part on a value of the designator respectively corresponding to the logical partition.

Some examples of the method 600 and the apparatus described herein may further include operations, features, circuitry, logic, means, or instructions for refraining from performing garbage collection on each physical partition of the plurality of physical partitions to which data associated with the one or more logical partitions has not been written.

Some examples of the method 600 and the apparatus described herein may further include operations, features, circuitry, logic, means, or instructions for performing, after performing the garbage collection on the physical partitions to which data associated with the one or more logical partitions has been written, garbage collection on each physical partition of the plurality of physical partitions to which data associated with the one or more logical partitions has not been written.

Some examples of the method 600 and the apparatus described herein may further include operations, features, circuitry, logic, means, or instructions for erasing each physical partition on which the garbage collection was performed.

Some examples of the method 600 and the apparatus described herein may further include operations, features, circuitry, logic, means, or instructions for receiving, from a host device for the one or more memory devices, an indication of the set of logical partitions.

In some examples of the method 600 and the apparatus described herein, the respective group of designators for at least one physical partition of the plurality of physical partitions may be updated before at least one write operation of the plurality of write operations may be performed.

In some examples of the method 600 and the apparatus described herein, each respective group of designators includes a bitmap, each bit in the bitmap including a respective designator of the group of designators.

In some examples of the method 600 and the apparatus described herein, operations, features, circuitry, logic, means, or instructions for updating the respective group of designators associated with each physical partition may include operations, features, circuitry, logic, means, or instructions for, for each physical partition of the plurality of physical partitions, setting a designator within the respective group of designators associated with the physical partition responsive to data associated with the respective logical partition corresponding to the designator being written to the physical partition.

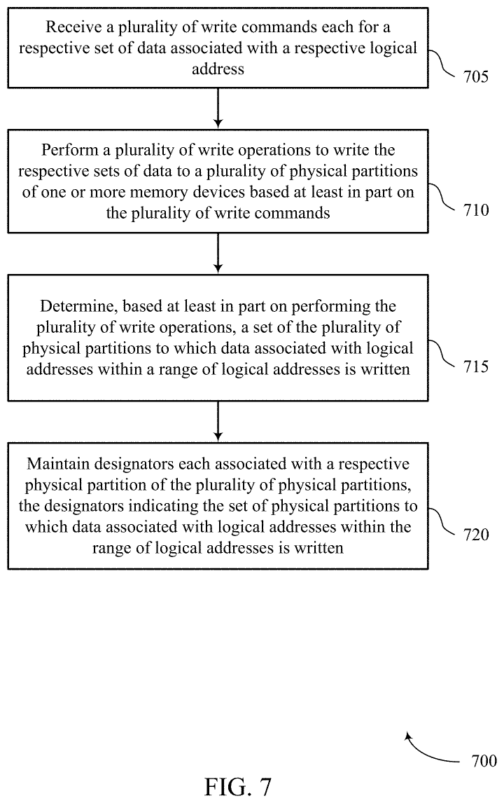

FIG. 7 shows a flowchart illustrating a method 700 that supports tracking data locations for improved memory performance in accordance with examples as disclosed herein. The operations of method 700 may be implemented by a memory system or its components as described herein. For example, the operations of method 700 may be performed by a memory system as described with reference to FIGS. 1 through 5. In some examples, a memory system may execute a set of instructions to control the functional elements of the device to perform the described functions. Additionally or alternatively, the memory system may perform aspects of the described functions using special-purpose hardware.

At 705, the method may include receiving a plurality of write commands each for a respective set of data associated with a respective logical address. The operations of 705 may be performed in accordance with examples as disclosed herein. In some examples, aspects of the operations of 705 may be performed by a receiver 525 as described with reference to FIG. 5.

At 710, the method may include performing a plurality of write operations to write the respective sets of data to a plurality of physical partitions of one or more memory devices based at least in part on the plurality of write commands. The operations of 710 may be performed in accordance with examples as disclosed herein. In some examples, aspects of the operations of 710 may be performed by a write manager 530 as described with reference to FIG. 5.

At 715, the method may include determining, based at least in part on performing the plurality of write operations, a set of the plurality of physical partitions to which data associated with logical addresses within a range of logical addresses is written. The operations of 715 may be performed in accordance with examples as disclosed herein. In some examples, aspects of the operations of 715 may be performed by a logical partition manager 540 as described with reference to FIG. 5.

At 720, the method may include maintaining designators each associated with a respective physical partition of the plurality of physical partitions, the designators indicating the set of physical partitions to which data associated with logical addresses within the range of logical addresses is written. The operations of 720 may be performed in accordance with examples as disclosed herein. In some examples, aspects of the operations of 720 may be performed by a designator manager 535 as described with reference to FIG. 5.

In some examples, an apparatus as described herein may perform a method or methods, such as the method 700. The apparatus may include, features, circuitry, logic, means, or instructions (e.g., a non-transitory computer-readable medium storing instructions executable by a processor) for receiving a plurality of write commands each for a respective set of data associated with a respective logical address, performing a plurality of write operations to write the respective sets of data to a plurality of physical partitions of one or more memory devices based at least in part on the plurality of write commands, determining, based at least in part on performing the plurality of write operations, a set of the plurality of physical partitions to which data associated with logical addresses within a range of logical addresses is written, and maintaining designators each associated with a respective physical partition of the plurality of physical partitions, the designators indicating the set of physical partitions to which data associated with logical addresses within the range of logical addresses is written.

Some examples of the method 700 and the apparatus described herein may further include operations, features, circuitry, logic, means, or instructions for updating the designators in connection with performing the plurality of write operations, where the updating may include, for each write operation associated with a physical partition to which data associated with the range of logical addresses is written in connection with the plurality of write operations, setting a bit within a bitmap, where the bit includes a designator associated with the physical partition.

Some examples of the method 700 and the apparatus described herein may further include operations, features, circuitry, logic, means, or instructions for receiving a command to purge data associated with the range of logical addresses and performing a garbage collection operation on each physical partition of the set of physical partitions based at least in part on the command to purge the data associated with the range of logical addresses.

In some examples of the method 700 and the apparatus described herein, operations, features, circuitry, logic, means, or instructions for performing the garbage collection operation on each physical partition of the set of physical partitions may include operations, features, circuitry, logic, means, or instructions for determining, based at least in part on a designator associated with the physical partition, whether the physical partition stores data associated with the range of logical addresses and performing garbage collection on the physical partition responsive to determining that the physical partition stores data associated with the range of logical addresses.

Some examples of the method 700 and the apparatus described herein may further include operations, features, circuitry, logic, means, or instructions for erasing each physical partition of the set of physical partitions after performing the garbage collection.

Some examples of the method 700 and the apparatus described herein may further include operations, features, circuitry, logic, means, or instructions for identifying the set of physical partitions, in response to the command to purge the data associated with the range of logical addresses, based at least in part on the designators.

In some examples of the method 700 and the apparatus described herein, the command to purge the data may indicate the range of logical addresses.

Some examples of the method 700 and the apparatus described herein may further include operations, features, circuitry, logic, means, or instructions for determining, based at least in part on performing the plurality of write operations, a second set of the plurality of physical partitions to which data associated with logical addresses within a second range of logical addresses is written, the second range of logical addresses within a same logical address space as the range of logical addresses, and maintaining second designators each associated with a respective physical partition of the plurality of physical partitions, the second designators indicating the second set of the plurality of physical partitions to which data associated with logical addresses within the second range of logical addresses is written.

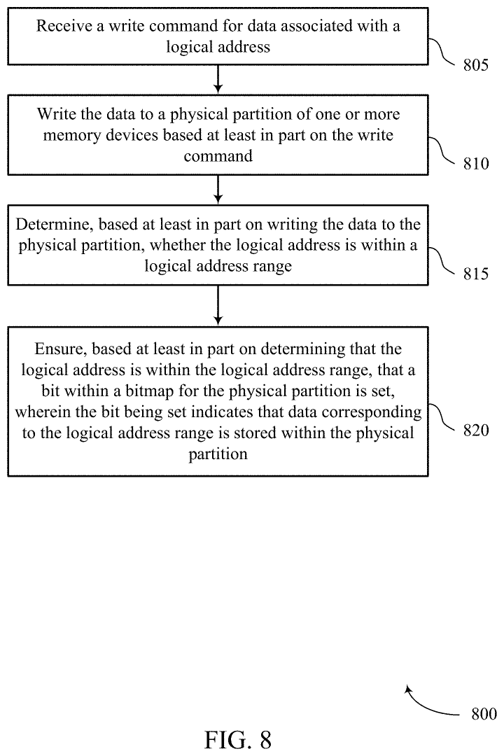

FIG. 8 shows a flowchart illustrating a method 800 that supports tracking data locations for improved memory performance in accordance with examples as disclosed herein. The operations of method 800 may be implemented by a memory system or its components as described herein. For example, the operations of method 800 may be performed by a memory system as described with reference to FIGS. 1 through 5. In some examples, a memory system may execute a set of instructions to control the functional elements of the device to perform the described functions. Additionally or alternatively, the memory system may perform aspects of the described functions using special-purpose hardware.

At 805, the method may include receiving a write command for data associated with a logical address. The operations of 805 may be performed in accordance with examples as disclosed herein. In some examples, aspects of the operations of 805 may be performed by a receiver 525 as described with reference to FIG. 5.

At 810, the method may include writing the data to a physical partition of one or more memory devices based at least in part on the write command. The operations of 810 may be performed in accordance with examples as disclosed herein. In some examples, aspects of the operations of 810 may be performed by a write manager 530 as described with reference to FIG. 5.

At 815, the method may include determining, based at least in part on writing the data to the physical partition, whether the logical address is within a logical address range. The operations of 815 may be performed in accordance with examples as disclosed herein. In some examples, aspects of the operations of 815 may be performed by a logical partition manager 540 as described with reference to FIG. 5.

At 820, the method may include ensuring, based at least in part on determining that the logical address is within the logical address range, that a bit within a bitmap for the physical partition is set, where the bit being set indicates that data corresponding to the logical address range is stored within the physical partition. The operations of 820 may be performed in accordance with examples as disclosed herein. In some examples, aspects of the operations of 820 may be performed by a designator manager 535 as described with reference to FIG. 5.

In some examples, an apparatus as described herein may perform a method or methods, such as the method 800. The apparatus may include, features, circuitry, logic, means, or instructions (e.g., a non-transitory computer-readable medium storing instructions executable by a processor) for receiving a write command for data associated with a logical address, writing the data to a physical partition of one or more memory devices based at least in part on the write command, determining, based at least in part on writing the data to the physical partition, whether the logical address is within a logical address range, and ensuring, based at least in part on determining that the logical address is within the logical address range, that a bit within a bitmap for the physical partition is set, where the bit being set indicates that data corresponding to the logical address range is stored within the physical partition.

Some examples of the method 800 and the apparatus described herein may further include operations, features, circuitry, logic, means, or instructions for receiving, after the write command, a purge command, determining, based at least in part on the purge command, whether the bit within the bitmap is set, and performing garbage collection on the physical partition based at least in part on determining that the bit within the bitmap is set.

It should be noted that the methods described above describe possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” refers to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed and second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed and second condition or action may occur directly as a result of the previous condition or action occurring independent of whether other conditions or actions occur. In some examples, a first condition or action may be performed and second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally or alternatively (e.g., in an alternative example) be performed “in direct response to” or “directly in response to” such other condition or action unless otherwise specified.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorous, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily doped, e.g., degenerate, semiconductor region. The source and drain may be separated by a lightly doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to providing an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processor, firmware, or any combination thereof. If implemented in software executed by a processor, the functions may be stored on or transmitted over, as one or more instructions or code, a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

For example, the various illustrative blocks and components described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may be implemented as a combination of computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read-only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk, and Blu-ray disc, where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus comprising:
one or more memory devices; and
a controller for the one or more memory devices and configured to cause the apparatus to:
receive a plurality of write commands, each of the plurality of write commands for a respective set of data associated with a respective logical partition of a set of logical partitions, each logical partition of the set of logical partitions corresponding to a respective range of logical addresses;
perform a plurality of write operations to write the respective sets of data to a plurality of physical partitions of the one or more memory devices based at least in part on the plurality of write commands, wherein each physical partition of the plurality of physical partitions is associated with a respective group of designators, and wherein each designator of the respective group of designators corresponds to a respective logical partition of the set of logical partitions; and
update, for each physical partition of the plurality of physical partitions, the respective group of designators to indicate, for each logical partition of the set of logical partitions, whether data associated with the logical partition has been written to the physical partition based at least in part on the plurality of write operations.

2. The apparatus of claim 1, wherein the controller is further configured to cause the apparatus to:
determine, based at least in part on performing each write operation of the plurality of write operations, whether the respective set of data associated with the write operation corresponds to any logical partition of the set of logical partitions, wherein the updating is based at least in part on determining whether the respective set of data corresponds to any logical partition of the set of logical partitions.

3. The apparatus of claim 1, wherein, to update the respective group of designators associated with each physical partition, the controller is further configured to cause the apparatus to:
for each write operation of the plurality of write operations:
determine a logical partition of the set of logical partitions associated with the respective set of data associated with the write operation; and
set, within the respective group of designators associated with the physical partition to which the respective set of data is written, a designator that corresponds to the determined logical partition.

4. The apparatus of claim 1, wherein the apparatus is configured to store each respective group of designators in the physical partition associated therewith.

5. The apparatus of claim 1, wherein the controller is further configured to cause the apparatus to:
receive a command to purge data associated with one or more logical partitions of the set of logical partitions; and
perform garbage collection on each physical partition of the plurality of physical partitions to which data associated with the one or more logical partitions has been written.

6. The apparatus of claim 5, wherein, to perform the garbage collection, the controller is further configured to cause the apparatus to:
for each physical partition of the plurality of physical partitions:
determine whether data associated with the one or more logical partitions has been written to the physical partition; and
perform garbage collection on the physical partition responsive to determining that data associated with the one or more logical partitions has been written to the physical partition.

7. The apparatus of claim 5, wherein the controller is further configured to cause the apparatus to:
determine, based at least in part on the command to purge data associated with the one or more logical partitions, one or more physical partitions of the plurality of physical partitions to which data associated with the one or more logical partitions has been written, wherein performing the garbage collection is based at least in part on determining the one or more physical partitions to which data associated with the one or more logical partitions has been written.

8. The apparatus of claim 7, wherein, to determine the one or more physical partitions to which data associated with the one or more logical partitions has been written, the controller is further configured to cause the apparatus to:
for each physical partition of the plurality of physical partitions:
evaluate the respective group of designators associated with the physical partition; and
determine, for each of the one or more logical partitions, whether data associated with the logical partition has been written to the physical partition based at least in part on a value of the designator respectively corresponding to the logical partition.

9. The apparatus of claim 5, wherein the controller is further configured to cause the apparatus to:
refrain from performing garbage collection on each physical partition of the plurality of physical partitions to which data associated with the one or more logical partitions has not been written.

10. The apparatus of claim 5, wherein the controller is further configured to cause the apparatus to:
perform, after performing the garbage collection on the physical partitions to which data associated with the one or more logical partitions has been written, garbage collection on each physical partition of the plurality of physical partitions to which data associated with the one or more logical partitions has not been written.

11. The apparatus of claim 5, wherein the controller is further configured to cause the apparatus to:
erase each physical partition on which the garbage collection was performed.

12. The apparatus of claim 1, wherein the controller is further configured to cause the apparatus to:
receive, from a host device for the one or more memory devices, an indication of the set of logical partitions.

13. The apparatus of claim 1, wherein the respective group of designators for at least one physical partition of the plurality of physical partitions is updated before at least one write operation of the plurality of write operations is performed.

14. The apparatus of claim 1, wherein each respective group of designators comprises a bitmap, each bit in the bitmap comprising a respective designator of the group of designators.

15. The apparatus of claim 1, wherein, to update the respective group of designators associated with each physical partition, the controller is further configured to cause the apparatus to:
for each physical partition of the plurality of physical partitions, set a designator within the respective group of designators associated with the physical partition responsive to data associated with the respective logical partition corresponding to the designator being written to the physical partition.

16. An apparatus comprising:
one or more memory devices; and
a controller for the one or more memory devices and configured to cause the apparatus to:
receive a plurality of write commands each for a respective set of data associated with a respective logical address;
perform a plurality of write operations to write the respective sets of data to a plurality of physical partitions of the one or more memory devices based at least in part on the plurality of write commands;
determine, based at least in part on performing the plurality of write operations, a set of the plurality of physical partitions to which data associated with logical addresses within a range of logical addresses is written; and
maintain designators each associated with a respective physical partition of the plurality of physical partitions, the designators indicating the set of physical partitions to which data associated with logical addresses within the range of logical addresses is written.

17. The apparatus of claim 16, wherein the controller is further configured to cause the apparatus to:
update the designators in connection with performing the plurality of write operations, the updating comprising:
for each write operation associated with a physical partition to which data associated with the range of logical addresses is written in connection with the plurality of write operations, setting a bit within a bitmap, wherein the bit comprises a designator associated with the physical partition.

18. The apparatus of claim 16, wherein the controller is further configured to cause the apparatus to:
receive a command to purge data associated with the range of logical addresses; and
perform a garbage collection operation on each physical partition of the set of physical partitions based at least in part on the command to purge the data associated with the range of logical addresses.

19. The apparatus of claim 18, wherein, to perform the garbage collection operation on each physical partition of the set of physical partitions, the controller is further configured to cause the apparatus to:
for each physical partition of the set of physical partitions:
determine, based at least in part on a designator associated with the physical partition, whether the physical partition stores data associated with the range of logical addresses; and
perform garbage collection on the physical partition responsive to determining that the physical partition stores data associated with the range of logical addresses.

20. The apparatus of claim 18, wherein the controller is further configured to cause the apparatus to:
erase each physical partition of the set of physical partitions after performing the garbage collection.

21. The apparatus of claim 18, wherein the controller is further configured to cause the apparatus to:
identify the set of physical partitions, in response to the command to purge the data associated with the range of logical addresses, based at least in part on the designators.

22. The apparatus of claim 18, wherein the command to purge the data indicates the range of logical addresses.

23. The apparatus of claim 16, wherein the controller is further configured to cause the apparatus to:
determine, based at least in part on performing the plurality of write operations, a second set of the plurality of physical partitions to which data associated with logical addresses within a second range of logical addresses is written, the second range of logical addresses within a same logical address space as the range of logical addresses; and
maintain second designators each associated with a respective physical partition of the plurality of physical partitions, the second designators indicating the second set of the plurality of physical partitions to which data associated with logical addresses within the second range of logical addresses is written.

24. An apparatus comprising:
one or more memory devices; and
a controller for the one or more memory devices and configured to cause the apparatus to:
receive a write command for data associated with a logical address;
write the data to a physical partition of the one or more memory devices based at least in part on the write command;
determine, based at least in part on writing the data to the physical partition, whether the logical address is within a logical address range; and
ensure, based at least in part on determining that the logical address is within the logical address range, that a bit within a bitmap for the physical partition is set, wherein the bit being set indicates that data corresponding to the logical address range is stored within the physical partition.

25. The apparatus of claim 24, wherein the controller is further configured to cause the apparatus to:
receive, after the write command, a purge command;
determine, based at least in part on the purge command, whether the bit within the bitmap is set; and
perform garbage collection on the physical partition based at least in part on determining that the bit within the bitmap is set.
